(19) United States
(12) Patent Application Publication
(10) Pub. No.: US 2026/0164346 A1
(43) Pub. Date: Jun. 11, 2026

(54) SELECTION OF ACESS POINTS TO SERVE USER EQUIPMENT IN A D-MIMO NETWORK

(71) Applicant: Telefonaktiebolaget LM Ericsson (publ), Stockholm (SE)

(72) Inventors: Roberto Pinto ANTONIOLI, Fortaleza - Ceará (BR); Iran MESQUITA BRAGA JUNIOR, Fortaleza (BR); Gabor FODOR, Hässelby (SE); Yuri C.B. SILVA, Fortaleza - CE (BR); Walter DA CRUZ FREITAS JUNIOR, Fortaleza - Ceará (BR)

(73) Assignee: Telefonaktiebolaget LM Ericsson (publ), Stockholm (SE)

(21) Appl. No.: 19/117,239

(22) PCT Filed: Oct. 6, 2022
(86) PCT No.: PCT/EP2022/077875

§ 371 Date: Mar. 31, 2025

(51) Int. Cl. H04W 48/20; H04L 5/00; H04W 8/22

(52) U.S. Cl. CPC H04W 48/20; H04L 5/0051; H04W 8/22

(57) ABSTRACT

There is provided techniques for selecting a cluster of APs to serve a UE in a D-MIMO network. A method is performed by a centralized node in the D-MIMO network. The method comprises obtaining a list of candidate APs from the UE via one of the APs in the D-MIMO network. The UE has from all APs in the list of candidate APs received downlink reference signals with a power higher than a power threshold. The method comprises selecting a cluster of APs to serve the UE in the D-MIMO network. The APs are selected from the list of candidate APs based on a cluster selection criterion operating on the list of candidate APs. The method comprises providing a list of the selected APs to the UE by transmitting the list of selected APs via one of the selected APs towards the UE.

### TECHNICAL FIELD

Embodiments presented herein relate to a method, a centralized node, a computer program, and a computer program product for selecting a cluster of access points to serve user equipment in a distributed multiple input multiple output network. Embodiments presented herein further relate to a method, a user equipment, a computer program, and a computer program product for the UE to be assigned the cluster of access points to serve the user equipment in the distributed multiple input multiple output network.

### BACKGROUND

Multi-antenna techniques can significantly increase the data rates and reliability of a wireless communication system. The performance is in particular improved if both the transmitter and the receiver are equipped with multiple antennas, which results in a multiple-input multiple-output (MIMO) communication channel. Such systems and/or related techniques are commonly referred to as MIMO systems, or just MIMO for short.

Distributed MIMO (D-MIMO, also referred to as cell-free massive MIMO, RadioStripes, RadioWeaves, and ubiquitous MIMO) is a candidate for the physical layer of the 6th generation (6G) telecommunication system. D-MIMO is based on geographically distributing the antennas of the network and configure them to operate phase-coherently together. Deployments of D-MIMO networks may be used to provide good coverage and high capacity for areas with high traffic requirements such as factory buildings, stadiums, office spaces and airports, just to mention a few examples.

In a typical architecture, multiple access points (APs) are interconnected and configured such that two or more APs can cooperate in coherent decoding of data from a given user equipment (UE) served by the network, and such that two or more APs can cooperate in coherent transmission of data to a UE. The APs might thus collectively define the access part of the D-MIMO network. Each AP has one or more antenna panel. Each antenna panel might comprise multiple antenna elements that are configured to operate phase-coherently together.

There are several options to deploy multiuser and massive MIMO networks. Some examples include deploying a large number of antenna elements co-located at a single site (base station or access point (AP) or transmission and reception point (TRP), hereinafter commonly referred to as AP without loss of generality), which is sometimes referred to as centralized massive MIMO. Other examples include deploying the antenna elements (or APs, where each AP might comprise one or multiple antenna elements) in a decentralized manner. In the decentralized manner the antenna elements are distributed over a geographical area (in a well-planned or random fashion) and one or more centralized units or gNBs (hereinafter commonly referred to as centralized unit without loss of generality) controlling all the antenna elements and connecting the APs to the core network. Combinations of the above examples are also possible.

Decentralized distribution is commonly referred to as distributed massive MIMO, or cell-free MIMO, in which the distributed antenna elements (or groups thereof) might be referred to as APs. In distributed massive MIMO, the antenna elements (or APs) are connected to the centralized unit using high-capacity backhaul links, such as fiber-optic cables, or millimeter wave-based links.

In the canonical form of the cell-free massive MIMO architecture, the network deployment follows a star topology, in which many distributed APs have independent fronthaul connections to a single centralized unit. However, practical deployments of cell-free systems in geographically large networks might not rely on a single centralized unit. Moreover, the assumption that signals transmitted from all APs would, by the UE served in the network, be processed in a coherent manner is also not scalable. In realistic large cell-free scenarios, the network deployment might therefore comprise multiple centralized units, in which each centralized unit controls a disjoint set of APs.

Both in the canonical and in deployments with multiple centralized units, achieving a sufficiently accurate relative timing and phase synchronization such that all APs can jointly exploit coherent signal processing can be challenging. Indeed, the communication theory underlying coherent transmission for cell-free systems assumes that a perfect timing synchronization exists, which is physically impossible over a large network, even if the clocks from the APs are synchronized. In other words, due to the geographical distribution of the APs, it will be impossible for the UE to receive signals from all APs within the cyclic prefix (CP). Besides that, joint coherent transmission requires that the signals to be transmitted to a certain UE be simultaneously available at multiple APs. Such strict requirements might be difficult to achieve even in centralized deployment.

A possible cell-free MIMO system with multiple centralized units could thus comprise multiple centralized units, each configured to control its own disjoint cluster of APs, without any assumptions that the multiple centralized units are mutually synchronized. Hence, the APs controlled by different centralized units might not be capable of serving the same UE using coherent transmission. Thus, perfect synchronization and simultaneous signal transmission and data availability is assumed only for the APs within each cluster of APs (as controlled by each centralized unit). In this context, a generalized transmission schemes could be used, in which a subset of APs controlled by a certain centralized unit may form a coherent group to coherently serve a given UE. In case a second coherent group controlled by a different centralized unit is also serving that UE, the transmissions from the two different coherent groups of APs are perceived by the UE as a non-coherent transmission. The non-coherent transmission from APs controlled by different centralized units occurs due to the difficulties involved in achieving enough synchronization among centralized units and simultaneous data availability at all APs of all centralized units.

Further, having all APs simultaneously serving all UEs is disadvantageous in terms of energy efficiency. On the other hand, in a user-centric approach only a subset of the APs simultaneously serves each UE. The APs serving each UE are typically the ones closest to each UE since those APs usually present the best channel conditions to that UE. Thus, depending on the geographical positions of the UEs and the APs as well as local propagation conditions, different UEs may be assigned to different numbers of APs.

In order to decide which APs will be serving which UE, a cluster formation algorithm could be executed. One possible approach for the development of clustering algorithms is to design a network-wide algorithm where the clusters of all UE served by the network are jointly considered. One issue with this approach is scalability since its complexity grows with the number of UEs (and APs) in the system. A scalable alternative to the network-wide algorithm is to consider user-centric clustering algorithms, where the cluster formation algorithm thus considers one UE at a time. However, since there might be a large number of UEs served by the network, such algorithms could be tedious.

Hence, there is a need for improved selection of which APs should serve which UE in MIMO networks, such as in D-MIMO networks or cell-free MIMO networks with multiple centralized units.

### SUMMARY

An object of embodiments herein is to address the above issues and enable efficient selection of which APs should serve which UEs in a D-MIMO network.

According to a first aspect there is presented a method for selecting a cluster of APs to serve a UE in a D-MIMO network. The method is performed by a centralized node in the D-MIMO network. The method comprises obtaining a list of candidate APs from the UE via one of the APs in the D-MIMO network. The UE has from all

APs in the list of candidate APs received downlink reference signals with a power higher than a power threshold. The method comprises selecting a cluster of APs to serve the UE in the D-MIMO network. The APs are selected from the list of candidate APs based on a cluster selection criterion operating on the list of candidate APs. The method comprises providing a list of the selected APs to the UE by transmitting the list of selected APs via one of the selected APs towards the UE.

According to a second aspect there is presented a centralized node for selecting a cluster of APs to serve a UE in a D-MIMO network. The centralized node comprises processing circuitry. The processing circuitry is configured to cause the centralized node to obtain a list of candidate APs from the UE via one of the APs in the D-MIMO network. The UE has from all APs in the list of candidate APs received downlink reference signals with a power higher than a power threshold. The processing circuitry is configured to cause the centralized node to select a cluster of APs to serve the UE in the D-MIMO network. The APs are selected from the list of candidate APs based on a cluster selection criterion operating on the list of candidate APs. The processing circuitry is configured to cause the centralized node to provide a list of the selected APs to the UE by transmitting the list of selected APs via one of the selected APs towards the UE.

According to a third aspect there is presented a centralized node for selecting a cluster of APs to serve a UE in a D-MIMO network. The centralized node comprises an obtain module configured to obtain a list of candidate APs from the UE via one of the APs in the D-MIMO network. The UE has from all APs in the list of candidate APs received downlink reference signals with a power higher than a power threshold. The centralized node comprises a select module configured to select a cluster of APs to serve the UE in the D-MIMO network. The APs are selected from the list of candidate APs based on a cluster selection criterion operating on the list of candidate APs. The centralized node comprises a provide module configured to provide a list of the selected APs to the UE by transmitting the list of selected APs via one of the selected APs towards the UE.

According to a fourth aspect there is presented a computer program for selecting a cluster of APs to serve UEs in a D-MIMO network, the computer program comprising computer program code which, when run on processing circuitry of a centralized node, causes the centralized node to perform a method according to the first aspect.

According to a fifth aspect there is presented a method for a UE to be assigned a cluster of APs to serve the UE in a D-MIMO network. The method is performed by the UE. The method comprises obtaining a list of candidate APs by sounding a radio environment of the UE for reception of downlink reference signals from the APs in the D-MIMO network and selecting to include in the list of candidate APs all of the APs for which the downlink reference signals were received with a power higher than a power threshold. The method comprises providing the list of candidate APs to a centralized node in the D-MIMO network by transmitting the list of candidate APs via one of the APs in the list of candidate APs towards the centralized node. The method comprises obtaining a list of selected APs from the centralized node via one of the APs in the list of selected APs, whereby the UE is assigned its cluster of APs. The method comprises performing a random access procedure with the APs in the list of selected APs for the APs in the list of selected APs to start serving the UE in the D-MIMO network.

According to a sixth aspect there is presented a UE to be assigned a cluster of APs to serve the UE in a D-MIMO network. The UE comprises processing circuitry. The processing circuitry is configured to cause the UE to obtain a list of candidate APs by sounding a radio environment of the UE for reception of downlink reference signals from the APs in the D-MIMO network and selecting to include in the list of candidate APs all of the APs for which the downlink reference signals were received with a power higher than a power threshold. The processing circuitry is configured to cause the UE to provide the list of candidate APs to a centralized node in the D-MIMO network by transmitting the list of candidate APs via one of the APs in the list of candidate APs towards the centralized node. The processing circuitry is configured to cause the UE to obtain a list of selected APs from the centralized node via one of the APs in the list of selected APs, whereby the UE is assigned its cluster of APs. The processing circuitry is configured to cause the UE to perform a random access procedure with the APs in the list of selected APs for the APs in the list of selected APs to start serving the UE in the D-MIMO network.

According to a seventh aspect there is presented a UE to be assigned a cluster of APs to serve the UE in a D-MIMO network. The UE comprises an obtain module configured to obtain a list of candidate APs by sounding a radio environment of the UE for reception of downlink reference signals from the APs in the D-MIMO network and selecting to include in the list of candidate APs all of the APs for which the downlink reference signals were received with a power higher than a power threshold. The UE comprises a provide module configured to provide the list of candidate APs to a centralized node in the D-MIMO network by transmitting the list of candidate APs via one of the APs in the list of candidate APs towards the centralized node. The UE comprises an obtain module configured to obtain a list of selected APs from the centralized node via one of the APs in the list of selected APs, whereby the UE is assigned its cluster of APs. The UE comprises a random access module configured to perform a random access procedure with the APs in the list of selected APs for the APs in the list of selected APs to start serving the UE in the D-MIMO network.

According to an eighth aspect there is presented a computer program for a UE to be assigned a cluster of APs to serve the UE in a D-MIMO network 100, the computer program comprising computer program code which, when run on processing circuitry of the UE, causes the UE to perform a method according to the fifth aspect.

According to a ninth aspect there is presented a computer program product comprising a computer program according to at least one of the fourth aspect and the eighth aspect and a computer readable storage medium on which the computer program is stored. The computer readable storage medium could be a non-transitory computer readable storage medium.

Advantageously, these aspects provide efficient selection of which APs should serve which UEs in a D-MIMO network, without suffering from the above issues.

Advantageously, these aspects are applicable to cell-free MIMO architecture with multiple centralized units.

Advantageously, these aspects exploit the cell-free MIMO architecture with multiple centralized units to enhance system key performance indicators (KPIs).

Advantageously, by means of these aspects, the inclusion of APs in some clusters can be avoided in case those APs are already overloaded due to high traffic load or have many connected UEs.

Advantageously, these aspects allow several KPIs, or metrics, to be used when deciding whether the UEs should be served by APs from one or multiple centralized units.

Other objectives, features and advantages of the enclosed embodiments will be apparent from the following detailed disclosure, from the attached dependent claims as well as from the drawings.

Generally, all terms used in the claims are to be interpreted according to their ordinary meaning in the technical field, unless explicitly defined otherwise herein. All references to “a/an/the element, apparatus, component, means, module, step, etc.” are to be interpreted openly as referring to at least one instance of the element, apparatus, component, means, module, step, etc., unless explicitly stated otherwise. The steps of any method disclosed herein do not have to be performed in the exact order disclosed, unless explicitly stated.

### BRIEF DESCRIPTION OF THE DRAWINGS

The inventive concept is now described, by way of example, with reference to the accompanying drawings, in which:

FIG. 1 is a schematic diagram illustrating a communication network according to embodiments;

FIGS. 2, 3, 4, and 5 are flowcharts of methods according to embodiments;

FIG. 6 is a signalling diagram according to embodiments;

FIG. 7 is a schematic diagram showing functional units of a centralized node according to an embodiment;

FIG. 8 is a schematic diagram showing functional modules of a centralized node according to an embodiment;

FIG. 9 is a schematic diagram showing functional units of a UE according to an embodiment;

FIG. 10 is a schematic diagram showing functional modules of a UE according to an embodiment; and

FIG. 11 shows one example of a computer program product comprising computer readable means according to an embodiment.

### DETAILED DESCRIPTION

The inventive concept will now be described more fully hereinafter with reference to the accompanying drawings, in which certain embodiments of the inventive concept are shown. This inventive concept may, however, be embodied in many different forms and should not be construed as limited to the embodiments set forth herein; rather, these embodiments are provided by way of example so that this disclosure will be thorough and complete, and will fully convey the scope of the inventive concept to those skilled in the art. Like numbers refer to like elements throughout the description. Any step or feature illustrated by dashed lines should be regarded as optional.

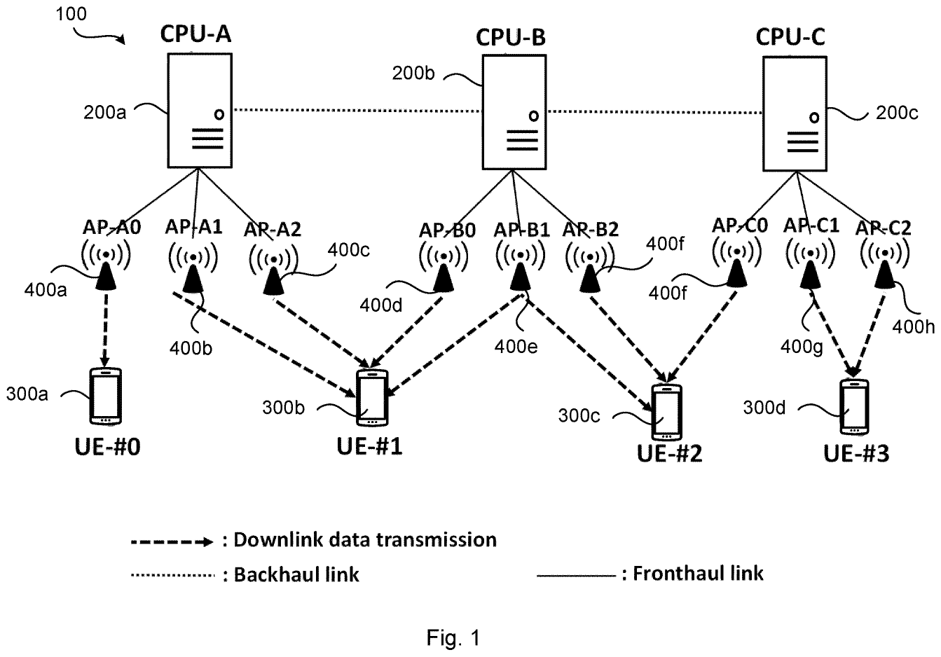

FIG. 1 is a schematic diagram illustrating a communication network 100 where embodiments presented herein can be applied. The communication network 100 comprises APs 400a:400h, also identified as AP-A0, AP-A1, . . . , AP-C2. In this respect, the herein disclosed embodiments are not limited to any particular number of APs. Each AP 400a:400h could be a (radio) access network node, radio base station, base transceiver station, node B (NB), evolved node B (eNB), gNB, integrated access and backhaul (IAB) node, one or more distributed antenna, or the like. The APs 400a:400h operatively connected over interfaces to one or more centralized nodes 200a, 200b, 200c, also identified as CPU-A, CPU-B, and CPU-C. The centralized nodes could represent an interface to a core network. Each centralized node 200a: 200c could be a (radio) base station, or the like. Each centralized node 200a: 200c controls its own disjoint set of APs. In the illustrative example of FIG. 1, CPU-X controls AP-XY, where X=A, B, C, and where Y=0, 1, 2. The APs 400a:400h are configured to provide network access to UEs 300a, 300b, 300c, 300d, also identified as UE-#0, . . . , UE-#3. Each such UE 300a: 300d could be any of a portable wireless device, mobile station, mobile phone, handset, wireless local loop phone, smartphone, laptop computer, tablet computer, wireless modem, wireless sensor device, Internet of Things (IoT) device, network equipped vehicle, or the like. Each such UE 300a: 300d is configured for wireless communication with one or more of the APs 400a:400h. In some aspects, the communication network 100 is a D-MIMO network. Hence, in some examples, the APs 400a:400h are part of a D-MIMO network. UE-#0 is served only by one single AP whereas UE-#1 is served by four APs. Further, AP-B1 serves both UE-#1 and UE-#2. Both UE #-1 and UE-#2 are served by APs in different disjoint sets (i.e., controlled by different centralized nodes). It could be a challenge to determine which one or more AP should serve one or more UE.

The first procedure executed by each UE when entering any mobile network is initial access. Initial access procedures are described in detail in 3GPP TS 38.213 V16.7.0, “3GPP Technical Specification Group Radio Access Network; NR; Physical layer procedures for control (Release 16)”, September 2021. In New Radio (NR) type of communication systems, the initial access procedure starts with the transmission of a synchronization signal block (SSB) burst, or message 0 (MSG0), from the APs towards the UE. Indeed, the APs transmits an SSB per beam and the UE sounds its environment, trying to detect the beam with the highest received power, reference signal received power (RSRP), and decoding the SSB associated with it.

After decoding an SSB and aligning a downlink-uplink beam pair, the UE sends a random access request, or message 1 (MSG1). As the network does not yet know the identity of the UE, the AP is expected to receive any MSG1 at specific time-frequency occasions, denoted random access channel (RACH) occasions. Thus, by detecting a signal (a random access request or MSG1) at specific RACH occasions the network associates a random access identity to that UE. Moreover, from the received signal the network knows the decoded SSB and thus the corresponding downlink beam. In the next step, a random access response (RAR) or message 2 (MSG2) scrambled with the random access identity of the UE is transmitted from the AP. This message indicates to the UE the granted uplink resources to be used in the next message and its new identity (i.e., the temporary network identity of the UE).

By transmitting message 3 (MSG3) the UE indicates the establishment cause and an identity for the UE. If two or more UEs have decoded the same SSB and have sent the same MSG1 at the same RACH occasions, these UEs are regarded as being in collision with respect to each other, i.e., having the same temporary identity (seen by the network). The identity of the UE is then used to resolve such a collision, if up to one uplink signal is correctly decoded by the AP (or gNB). The initial access procedure ends with transmission from the AP of message 4 (MSG4), where the collision (if any) is resolved, and where the radio bearer configuration is informed and master cell group information is provided to the UE. Moreover, at this stage, the temporary identity of the UE is discarded and replaced by the cell identity of the UE.

As disclosed above, there is a need for improved selection of which APs should serve which UE in MIMO systems, such as in distributed MIMO systems or cell-free MIMO systems with multiple centralized units.

In further detail, since APs controlled by different centralized units might not be able to coherently transmit data to some UEs, some issues relate to forming clusters of APs to serve the UE where the APs are controlled by different centralized units.

In yet further details, some issues concern the type of information required to be accessed by the centralized units, or needed to be exchanged between the centralized units, when forming clusters of APs to serve the UE.

In yet further details, some issues concern the one or more criterion to be applied when deciding whether a given UE is to be served by APs controlled by a single centralized unit or from APs controlled by different centralized unit. This might impact how the clusters are formed and also the information exchanged between the centralized units.

In yet further aspects, some issues concern how to enhance the system performance when the UEs are allowed to establish connections to APs controlled by one or more centralized units.

The embodiments disclosed herein in particular relate to techniques for selecting a cluster of APs 400a:400h to serve UEs 300a: 300d in a D-MIMO network 100 and a UE 300a: 300d to be assigned a cluster of APs 400a:400h to serve the UE 300a: 300d in the D-MIMO network 100. In order to obtain such techniques there is provided a centralized node 200a: 200c, a method performed by the centralized node 200a: 200c, a computer program product comprising code, for example in the form of a computer program, that when run on processing circuitry of the centralized node 200a: 200c, causes the centralized node 200a: 200c to perform the method. In order to obtain such techniques there is further provided a UE 300a: 300d, a method performed by the UE 300a: 300d, and a computer program product comprising code, for example in the form of a computer program, that when run on processing circuitry of the UE 300a: 300d, causes the UE 300a: 300d to perform the method.

According to at least some of the herein disclosed embodiments, the centralized units are enabled to, with exchanging a limited amount of information, form the cluster of APs to serve each UE. Based on some information received by a centralized unit from a given UE, this centralized unit communicates information with other centralized units and decides whether the given UE will be served by APs controlled by one or multiple centralized units. The cluster formation procedure executed at the centralized units considers the inherent benefits of distributed MIMO systems with multiple centralized nodes, KPIs to be optimized in the system, and the overload situation at each of the APs. The decision taken by the centralized units is then informed to the UE, which triggers the initial procedure with the selected APs.

It is therefore in some aspects assumed that the centralized units have knowledge of some metrics related to the link quality between each UE and at least some of the APs. This link quality is assumed to vary very slowly over time, such as with the large-scale fading value of the link. This knowledge can be obtained by a regular channel estimation process, where, for example, the UE periodically or non-periodically, transmits uplink reference signals to the APs, either in conjunction with the transmission of data or when requested by the centralized units, or APs.

Further, it is not a requirement that APs controlled by different centralized units are capable of serving a certain UE using coherent transmission, and hence the herein disclosed embodiments do not rely on, or require, that any synchronization criterion is fulfilled between APs controlled by different centralized units. A generalized transmission scheme can therefore be adopted, in which a subset of APs controlled by a certain centralized unit may form a coherent group to coherently serve a given UE. Then, in case a second coherent group of APs controlled by a different centralized unit is also serving that same given UE, the transmissions from the two different coherent groups of APs are perceived by the UE as a non-coherent transmission.

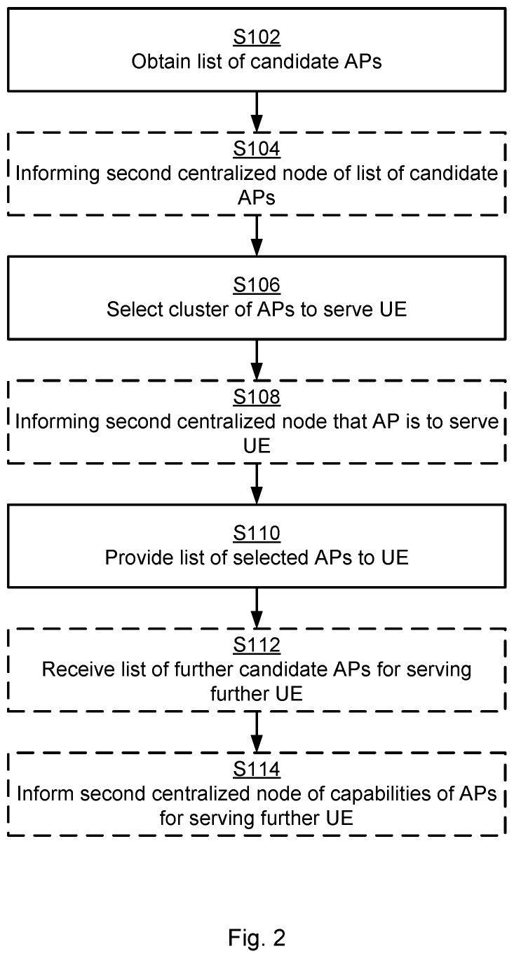

Reference is now made to FIG. 2 illustrating a method for selecting a cluster of APs 400a:400h to serve UEs 300a:300d in a D-MIMO network 100 as performed by one centralized node 200a in the D-MIMO network 100 according to an embodiment.
S102: The centralized node 200a obtains a list of candidate APs 400a:400h from the UE 300a:300d via one of the APs 400a:400h in the D-MIMO network 100. The UE 300a:300d has from all APs 400a:400h in the list of candidate APs 400a:400h received downlink reference signals with a power higher than a power threshold.
S106: The centralized node 200a selects a cluster of APs 400a:400h to serve the UE 300a:300d in the D-MIMO network 100. The APs 400a:400h are selected from the list of candidate APs 400a:400h based on a cluster selection criterion operating on the list of candidate APs 400a:400h.
S110: The centralized node 200a provides a list of the selected APs 400a:400h to the UE 300a:300d by transmitting the list of selected APs 400a:400h via one of the selected APs 400a:400h (or via the AP from which the list of candidate APs 400a:400h was obtained from the UE 300a:300d) towards the UE 300a:300d.

The centralized node 200a is thereby enabled to select an optimized cluster of APs to serve each UE in a D-MIMO network with one or more centralized nodes 200a:200c controlling its own group of APs.

Embodiments relating to further details of selecting a cluster of APs 400a:400h to serve UEs 300a:300d in a D-MIMO network 100 as performed by the centralized node 200a will now be disclosed.

As in FIG. 1, the D-MIMO network 100 might comprise more than one centralized node 200a:200c. The centralized node 200a might therefore be regarded as a first centralized node 200a, where the D-MIMO network 100 further comprises (at least) a second centralized node 200b:200c. In some embodiments, the list of candidate APs 400a:400h comprises at least a first AP 400a controlled by the first centralized node 200a and at least a second AP 400d controlled by the second centralized node 200b:200c.

In some embodiments, the AP 400a:400h from which the list of candidate APs 400a:400h is obtained is controlled by the first centralized node 200a. As will be disclosed below, the AP 400a:400h from which the list of candidate APs 400a:400h is obtained is denoted master AP for the UE and the centralized node 200a for the master AP is denoted master centralized node.

In some embodiments, the list of selected APs 400a:400h comprises at least a first AP 400a controlled by the first centralized node 200a and at least a second AP 400d controlled by the second centralized node 200b. Hence, the list of selected APs 400a:400h might contain some APs controlled by the master centralized node as well as some APs controlled by another centralized node.

There could be different cluster selection criteria. Embodiments relating thereto will now be disclosed.

In some aspects the cluster selection is driven by some optimization criterion. In particular, in some embodiments, the cluster selection criterion is an optimization criterion.

There could be different examples of optimization criteria.

Some optimization criteria pertain to maximizing the total system rate and/or maximizing the minimum UE data rate. Hence, in some non-limiting examples, the optimization criterion pertains to at least one of: maximizing a system data rate for the D-MIMO network 100, maximizing a minimum individual data rate for the UE 300a:300d.

In further aspects, the cluster selected is based on the historic link quality between the UE 300a:300d and the candidate APs 400a:400h. In particular, in some embodiments, the cluster selection criterion is based on historical link quality values for previous links between the UE 300a:300d and APs 400a:400h in the D-MIMO network 100.

In further aspects, the cluster selected is based on one or more channel-related metrics, such as the combined pathloss and shadowing of the channel between a given AP and the UE. In particular, in some embodiments, the historical link quality values pertain to pathloss and/or shadowing.

In yet further aspects, the APs are randomly selected among the candidate APs 400a:400h. In particular, in some embodiments, the cluster selection criterion comprises to randomly select the cluster of APs 400a:400h to serve the UE 300a:300d from the list of candidate APs 400a:400h.

Further, in some aspects the UE 300a:300d is to be served only by a group of APs 400a:400h which are all controlled by one and the same centralized node. That is, in some embodiments, the cluster selection criterion comprises to only select APs 400a:400h that are controlled by either only the first centralized node 200a or only APs 400a:400h that are controlled by the second centralized node 200b to serve the UE 300a:300d. In the case that only APs from a non-master centralized node are selected to form the cluster of APs to the intended UE, then that centralized node becomes the master centralized node to that UE and one of the selected APs becomes the master AP. This approach forms a single coherent group serving the UE, which usually provides a high system data rate.

Another option is to select APs controlled by two or more different centralized nodes. This approach forms multiple coherent groups of APs, which will be transmitting in a non-coherent fashion to the UE, to serve the UE. Such an approach may help improving the minimum data rate of the UE without compromising too much the total system data rate. Further, the multiple coherent groups of APs could also transmit in a coherent fashion to the UE.

In some examples, the cluster of APs to serve a given UE is selected based on the following rule:

$$\frac{{\sum }_{m ∈ {A}_{k}} {β}_{m , k}}{{\sum }_{{m}^{{}_{′}} ∈ {C}_{k}} {β}_{{m}^{{}_{′}} , k}} \geq α$$

where β_{m,k} is a channel-related metric (such as the combined pathloss and shadowing) of the channel between AP m and UE k, where Aₖ is the set of APs that will be serving UE k, where Cₖ is the set of APs in the list of candidate APs for serving UE k, and where α is a threshold that indicates a desired value of total power received by UE k. The first step of this algorithm is to order the values of β_{m,k} in descending order. Then, the APs are added one-by-one to the set Aₖ, the value of the fraction is computed and checked if it is higher than or equal to a. If so, no more APs are added and the set Aₖ is formed. By this scheme, the APs that have the strongest channel and that contribute to more than a % of the total power received by UE k are selected from Cₖ.

In some aspects, the centralized node 200a is configured to inform the surrounding centralized nodes 200b, 200c about the received list of candidate APs 400a:400h. This could be the case when the received list of APs 400a:400h contains an identifier, such as a physical cell identifier (PCIDs) of APs 400a:400h that are not controlled by the centralized node 200a itself. Hence, in some embodiments, the centralized node 200a is configured to perform (optional) step S104.
S104: The centralized node 200a informs the second centralized node 200b, 200c of the list of candidate APs 400a:400h.

In some aspects, the centralized node 200a is configured to inform the surrounding centralized nodes 200b, 200c about the selected list of candidate APs 400a:400h. This could be the case when the selected list of APs comprises APs 400a:400h controlled by different centralized nodes. Hence, in some embodiments, the centralized node 200a is configured to perform (optional) step S108.
S108: The centralized node 200a:200c informs the second centralized node 200b that the at least one second AP 400d is to serve the UE 300a:300d in the D-MIMO network 100.

In some aspects, the centralized node 200a is configured to inform the surrounding centralized nodes 200b, 200c about the availability of its APs 400a:400h for forming a cluster of APs 400a:400h. This could be the case when the centralized node 200a receives a list of candidate APs 400a:400h from another centralized node 200b, 200c. This could be the case when the centralized node 200a is not the master centralized node. Hence, in some embodiments, the centralized node 200a is configured to perform (optional) steps S112 and S114.
S112: The centralized node 200a:200c receives, from the second centralized node 200b, a list of further candidate APs 400a:400h for serving a further UE 300a:300d in the D-MIMO network 100.
S114: The centralized node 200a:200c informs the second centralized node 200b of a capability of the further candidate APs 400a:400h for serving the further UE 300a:300d.

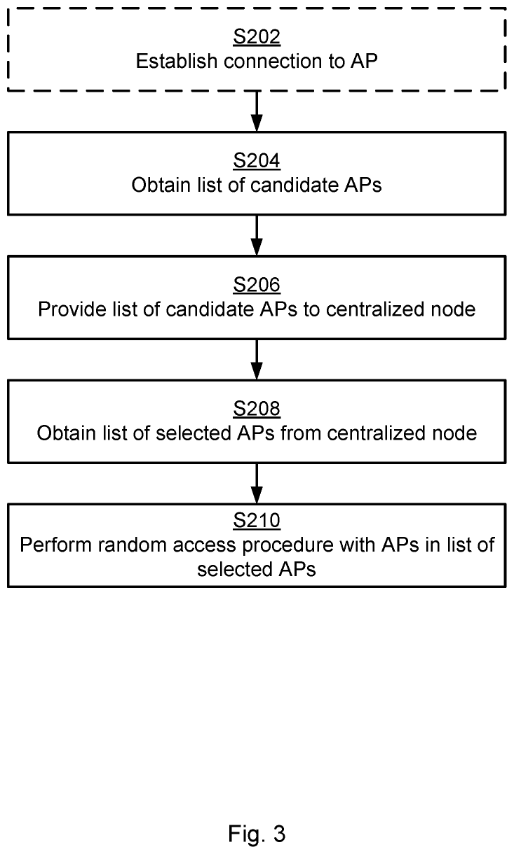

Reference is now made to FIG. 3 illustrating a method for a UE 300a:300d to be assigned a cluster of APs 400a:400h to serve the UE 300a:300d in a D-MIMO network 100 as performed by the UE 300a:300d according to an embodiment.
S204: The UE 300a:300d obtains a list of candidate APs 400a:400h. In order to do so, the UE 300a:300d sounds a radio environment of the UE 300a:300d for reception of downlink reference signals from the APs 400a:400h in the D-MIMO network 100. The UE 300a:300d selects to include in the list of candidate APs 400a:400h all of the APs 400a:400h for which the downlink reference signals were received with a power higher than a power threshold.
S206: The UE 300a:300d provides the list of candidate APs 400a:400h to the centralized node 200a:200c in the D-MIMO network 100. The list of candidate APs 400a:400h is transmitted towards the centralized node 200a:200c via one of the APs 400a:400h in the list of candidate APs 400a:400h.
S208: The UE 300a:300d obtains a list of selected APs 400a:400h from the centralized node 200a:200c via one of the APs 400a:400h in the list of selected APs 400a:400h. The UE 300a:300d is thereby assigned its cluster of APs 400a:400h.
S210: The UE 300a:300d performs a random access procedure with the APs 400a:400h in the list of selected APs 400a:400h. The random access procedure is performed for the APs 400a:400h in the list of selected APs 400a:400h to start serving the UE 300a:300d in the D-MIMO network 100.

Embodiments relating to further details of the UE 300a:300d to be assigned a cluster of APs 400a:400h to serve the UE 300a:300d in a D-MIMO network 100 will now be disclosed.

In some aspects, the UE 300a:300d first connects to a single AP. In particular, in some embodiment, the UE 300a:300d is configured to perform (optional) step S202.
S202: The UE 300a:300d establishes a connection to one of the APs 400a:400h in the D-MIMO network 100 before obtaining the list of candidate APs 400a:400h. The list of candidate APs 400a:400h is sent to this one of the APs 400a:400h. The list of selected APs 400a:400h is received from this one of the APs 400a:400h.

This first AP 400a is then referred to as master AP and the centralized node controlling this AP is referred to as master centralized node.

As disclosed above, in some aspects, the list of candidate APs 400a:400h comprises some APs 400a:400h controlled by the master centralized node and some APs controlled by another (non-master) centralized node.

That is, in some embodiments, the list of candidate APs 400a:400h comprises at least a first AP 400a controlled by the first centralized node 200a and at least a second AP 400d controlled by the second centralized node 200b.

The list of candidate APs 400a:400h is then sent to the master centralized node via the master AP. That is, in some embodiments, the one of the APs 400a:400h is controlled by the first centralized node 200a.

As disclosed above, in some aspects, the list of selected APs 400a:400h comprises some APs 400a:400h controlled by the master centralized node and some APs selected by another (non-master) centralized node. That is, in some embodiments, the list of selected APs 400a:400h comprises at least a first AP 400a controlled by the first centralized node 200a and at least a second AP 400d controlled by the second centralized node 200b.

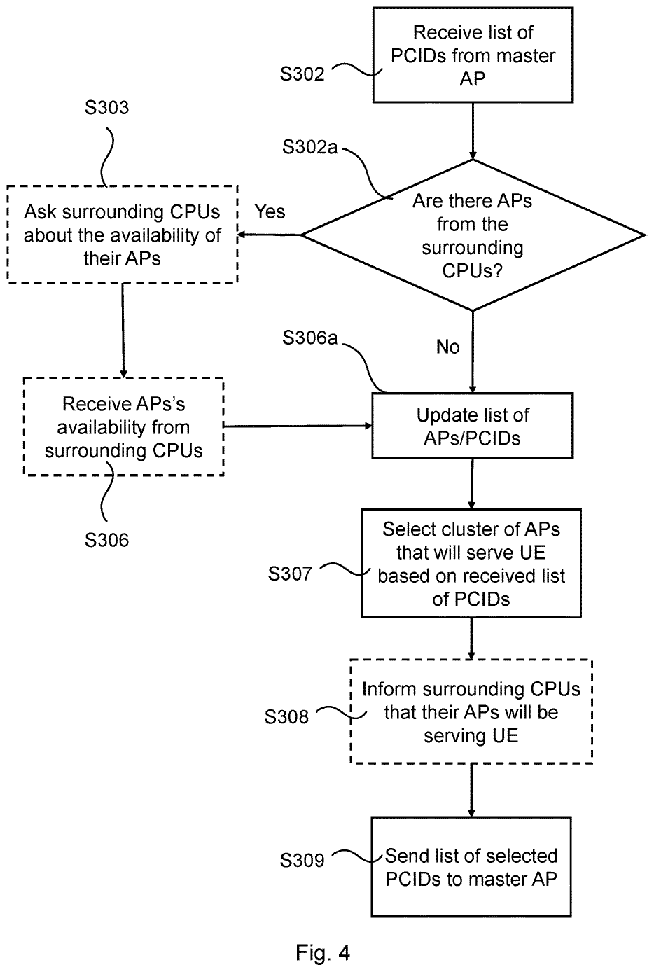

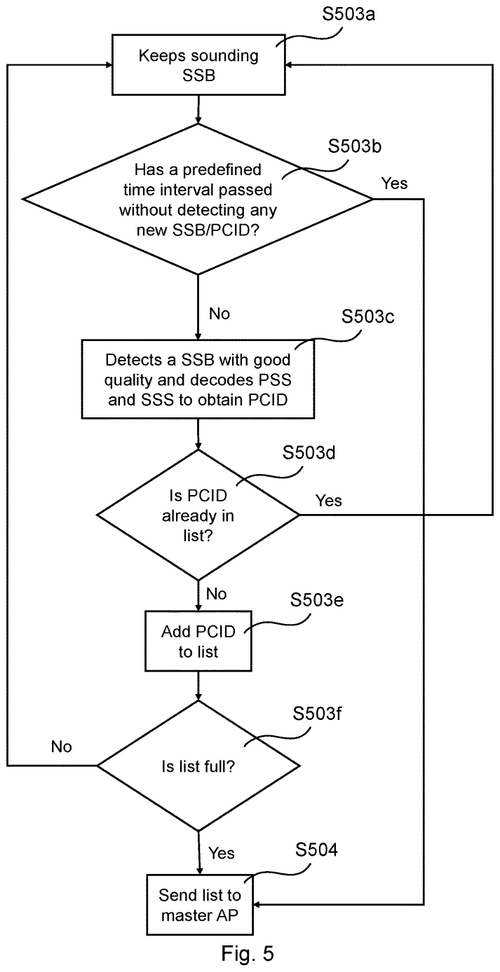

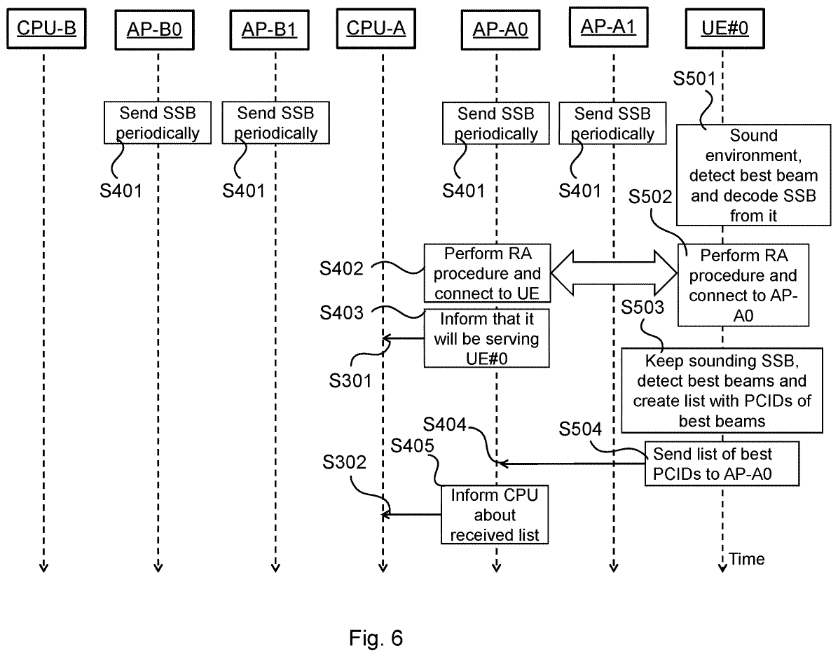

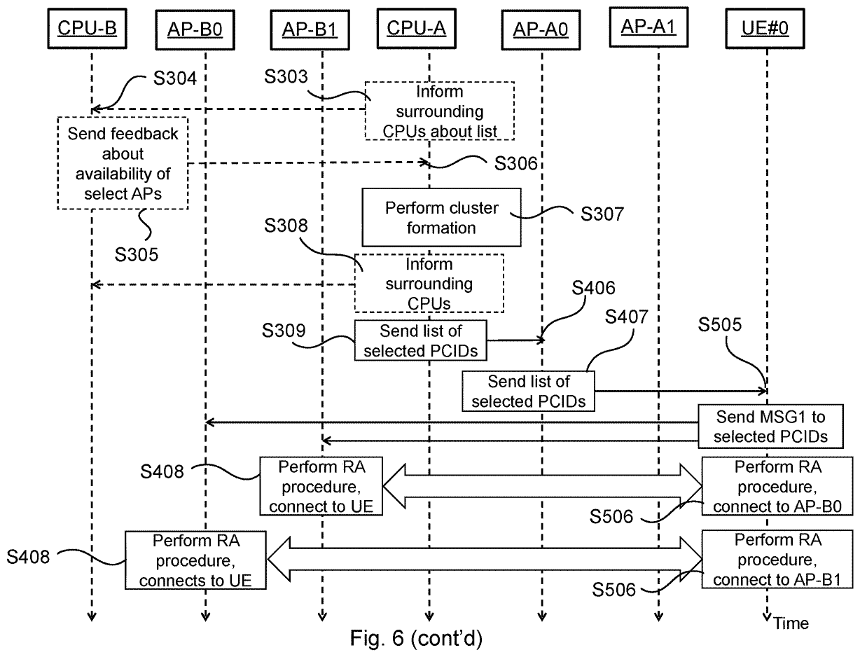

One particular embodiment for selecting which APs 400a:400h to serve which UEs 40300a:300d in a D-MIMO network 100 based on at least some of the above disclosed embodiments will now be disclosed in detail with reference to the flowcharts of FIG. 4 and FIG. 5 as well as the signalling diagram of FIG. 6.

In the illustrative example at hand, there are two centralized units (below denoted CPU-A and CPU-B, respectively) and four APs (below denoted AP-A0, AP-A1, AP-B0, and AP-B1, respectively). CPU-A controls AP-A0 and AP-A1, whilst CPU-B controls AP-B0 and AP-B1. A set of APs to serve a UE (below denoted UE #0) is to be selected. As will be explained in the following, AP-A0 is selected as the master AP for UE #0, and thus CPU-A is the master CPU for UE #0. During the executing of the clustering algorithm, CPU-A selects AP-B0 and AP-B1 from CPU-B to form the cluster to serve UE #0. In FIG. 4 is shown steps of a method performed by CPU-A. In FIG. 5 is shown steps of a method performed by UE #0. In FIG. 6 is shown steps of a method performed by CPU-A, CPU-B, AP-A0, AP-A1, AP-B0, AP-B1, and UE #0.

Actions as performed by CPU-A and CPU-B will be disclosed next.
S301: CPU-A receives a message from AP-A0. The message at least comprises an identifier of UE #0. As is further disclosed below, this implies that AP-A0 is the master AP for UE #0. In turn, this implies that CPU-A is the master CPU for UE #0.
S302: CPU-A receives from AP-A0 a list of candidate APs for forming the cluster of APs to serve a UE #0. As is further disclosed below, this list comprises the PCIDs of the best APs selected by that UE.
S303: CPU-A informs CPU-B about the received list of candidate APs for UE #0. S303 is only performed if CPU-B notices that the received list of PCIDs comprises at least one PCID of an AP not controlled by CPU-A, as checked in step S302a.
S304: CPU-B receives the list of candidate APs from CPU-A.
S305: CPU-B informs CPU-A about the availability of AP-B0 and AP-B1 for forming the cluster of APs to UE #0.

The availability is based on some criterion, such as the traffic load or current number of served UEs at AP-B0 and AP-B1.
S306: CPU-A receives the list of available APs from CPU-B. The list is updated accordingly (S306a).
S307: CPU-A selects for UE #0 a subset (or cluster) of APs that will be serving UE #0. In this respect, CPU-A selects the subset (or cluster) of APs to serve UE #0 based on any of the above disclosed cluster selection criteria operating on the list of candidate APs, with possible constraints defined by the list of available APs received from CPU-B.
S308: CPU-A informs CPU-B that AP-B0 and AP-B1 controlled by CPU-B will be serving UE #0.
S309: CPU-A sends the list of selected APs to AP-A0.

Actions as performed by AP-A0, AP-A1, AP-B0, AP-B1 will be disclosed next.
S401: AP-A0, AP-A1, AP-B0, AP-B1 each sends periodically SSB bursts.
S402: AP-A0 performs a 3GPP-based RA procedure to establish a connection for UE #0.
S403: AP-A0 sends a message to CPU-A, where the message at least comprises an identifier of UE #0. The centralized node at this stage is referred to as master CPU for UE #0.
S404: AP-A0 receives from UE #0 a list of candidate APs for forming the cluster of APs to serve UE #0. As will be further disclosed below, this list comprises the PCIDs of the best APs selected by UE #0.
S405: AP-A0 sending the list of candidate APs to CPU-A.
S406: AP-A0 receives from CPU-A the list of selected APs.
S407: AP-A0 sends the list of selected APs to UE #0.
S408: AP-B0, AP-B1 perform a 3GPP-based RA procedure in order to establish a connection for UE #0.

Actions as performed by UE #0 will be disclosed next.

S501: UE #0 sounds the environment to detect the best beams from the SSB burst as transmitted from the APs as disclosed above.

S502: UE #0 performs 3GPP-based RA procedure for a connection to be established to this AP, i.e., AP-A0. AP-A0 is therefore referred as master AP.

S503: UE #0 keeps sounding SSB bursts to detect the N best beams and creates a list with the PCIDs of the APs transmitting the beams that are included in the list.

The detailed procedure to create this list of best PCIDs is shown in FIG. 4.

S503a: UE #0 keeps sounding the SSB bursts S503b: It is checked whether a predefined time interval has expired without UE #0 having detected any new SSB (or PCID) or not. If yes, step S504 is entered. If no, step S305c is entered.

S503c: UE #0 detects an SSB with an RSRP value above a threshold value. UE #0 decodes the primary synchronization signal (PSS) and the secondary synchronization signal (SSS) of this SSB to obtain the PCID.

S503d: It is checked whether the PCID is in the list of best PCIDs or not. If yes, step S503a is entered. If no, step S503e is entered.

S503e: The PCID is added to the list of best PCIDs.

S503f: It is checked whether the list of best PCIDs is full or not. If yes, step S504 is entered. If no, step S503a is entered.

S504: UE #0 sends the list of best PCIDs to the master AP.

S505: UE #0 receives from the master AP a list of selected APs that form the cluster of APs serving UE #0.

S506: UE #0 Contacts the APs in the list of selected APs to perform a 3GPP-based RA procedure for connections to be established to these APs.

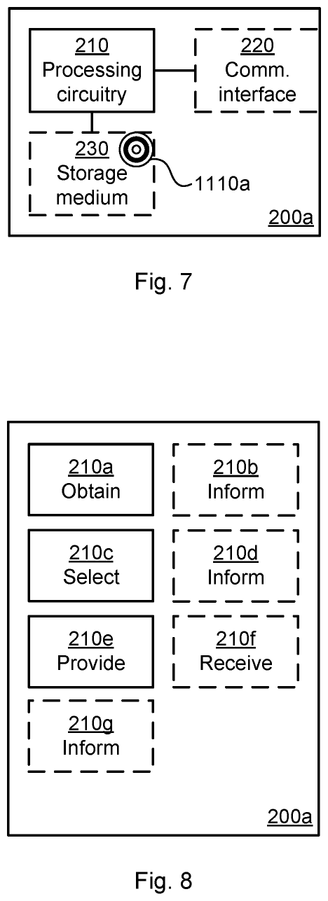

FIG. 7 schematically illustrates, in terms of a number of functional units, the components of a centralized node 200a:200c according to an embodiment. Processing circuitry 210 is provided using any combination of one or more of a suitable central processing unit (CPU), multiprocessor, microcontroller, digital signal processor (DSP), etc., capable of executing software instructions stored in a computer program product 1110a (as in FIG. 11), e.g. in the form of a storage medium 230. The processing circuitry 210 may further be provided as at least one application specific integrated circuit (ASIC), or field programmable gate array (FPGA).

Particularly, the processing circuitry 210 is configured to cause the centralized node 200a:200c to perform a set of operations, or steps, as disclosed above. For example, the storage medium 230 may store the set of operations, and the processing circuitry 210 may be configured to retrieve the set of operations from the storage medium 230 to cause the centralized node 200a:200c to perform the set of operations. The set of operations may be provided as a set of executable instructions. Thus the processing circuitry 210 is thereby arranged to execute methods as herein disclosed.

The storage medium 230 may also comprise persistent storage, which, for example, can be any single one or combination of magnetic memory, optical memory, solid state memory or even remotely mounted memory.

The centralized node 200a:200c may further comprise a communications interface 220 for communications with other entities, functions, nodes, and devices, such as APs 400a:400h, UEs 300a:300d, and other centralized nodes 200a:200c, directly or indirectly, as in FIG. 1. As such the communications interface 220 may comprise one or more transmitters and receivers, comprising analogue and digital components.

The processing circuitry 210 controls the general operation of the centralized node 200a:200c e.g. by sending data and control signals to the communications interface 220 and the storage medium 230, by receiving data and reports from the communications interface 220, and by retrieving data and instructions from the storage medium 230. Other components, as well as the related functionality, of the centralized node 200a:200c are omitted in order not to obscure the concepts presented herein.

FIG. 8 schematically illustrates, in terms of a number of functional modules, the components of a centralized node 200a:200c according to an embodiment. The centralized node 200a:200c of FIG. 8 comprises a number of functional modules; an obtain module 210a configured to perform step S102, a select module 210c configured to perform step S106, and a provide module 210e configured to perform step S110. The centralized node 200a:200c of FIG. 8 may further comprise a number of optional functional modules, such as any of an inform module 210b configured to perform step S104, an inform module 210d configured to perform step S108, a receive module 210f configured to perform step S112, an inform module 210g configured to perform step S114.

In general terms, each functional module 210a:210g may be implemented in hardware or in software. Preferably, one or more or all functional modules 210a:210g may be implemented by the processing circuitry 210, possibly in cooperation with the communications interface 220 and/or the storage medium 230. The processing circuitry 210 may thus be arranged to from the storage medium 230 fetch instructions as provided by a functional module 210a:210g and to execute these instructions, thereby performing any steps of the centralized node 200a:200c as disclosed herein.

The centralized node 200a:200c may be provided as a standalone device or as a part of at least one further device. For example, the centralized node 200a:200c may be provided in a node of the radio access network or in a node of the core network. Alternatively, functionality of the centralized node 200a:200c may be distributed between at least two devices, or nodes. These at least two nodes, or devices, may either be part of the same network part (such as the radio access network or the core network) or may be spread between at least two such network parts. In general terms, instructions that are required to be performed in real time may be performed in a device, or node, operatively closer to the cell than instructions that are not required to be performed in real time. Thus, a first portion of the instructions performed by the centralized node 200a:200c may be executed in a first device, and a second portion of the of the instructions performed by the centralized node 200a:200c may be executed in a second device; the herein disclosed embodiments are not limited to any particular number of devices on which the instructions performed by the centralized node 200a:200c may be executed. Hence, the methods according to the herein disclosed embodiments are suitable to be performed by a centralized node 200a:200c residing in a cloud computational environment. Therefore, although a single processing circuitry 210 is illustrated in FIG. 7, the processing circuitry 210 may be distributed among a plurality of devices, or nodes. The same applies to the functional modules 210a:210g of FIG. 8 and the computer program 1120a of FIG. 11.

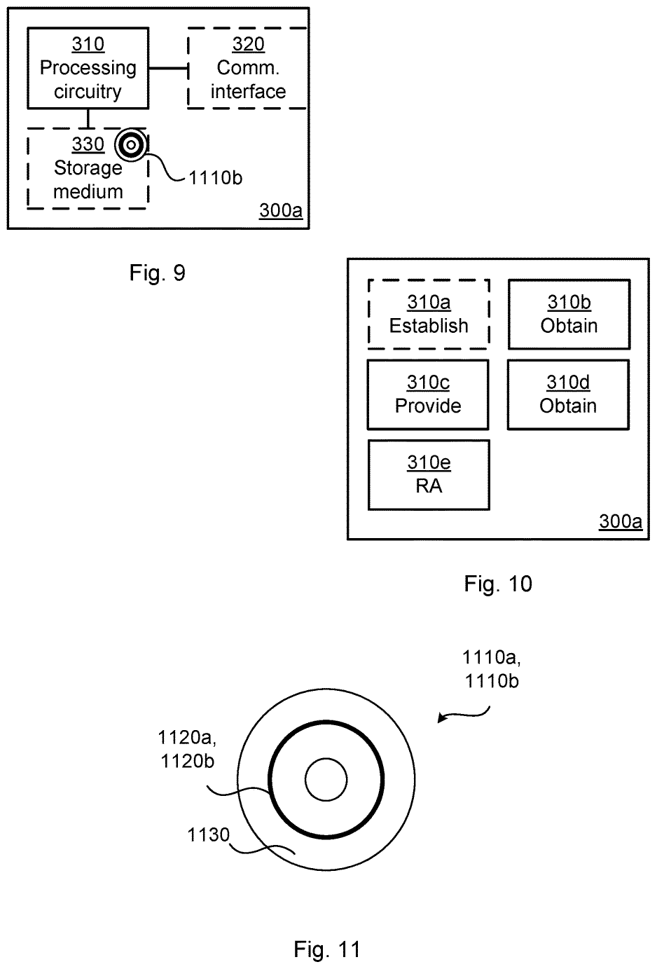

FIG. 9 schematically illustrates, in terms of a number of functional units, the components of a UE 300a:300d according to an embodiment. Processing circuitry 310 is provided using any combination of one or more of a suitable central processing unit (CPU), multiprocessor, microcontroller, digital signal processor (DSP), etc., capable of executing software instructions stored in a computer program product 1110b (as in FIG. 11), e.g. in the form of a storage medium 330. The processing circuitry 310 may further be provided as at least one application specific integrated circuit (ASIC), or field programmable gate array (FPGA).

Particularly, the processing circuitry 310 is configured to cause the UE 300a:300d to perform a set of operations, or steps, as disclosed above. For example, the storage medium 330 may store the set of operations, and the processing circuitry 310 may be configured to retrieve the set of operations from the storage medium 330 to cause the UE 300a:300d to perform the set of operations. The set of operations may be provided as a set of executable instructions. Thus the processing circuitry 310 is thereby arranged to execute methods as herein disclosed.

The storage medium 330 may also comprise persistent storage, which, for example, can be any single one or combination of magnetic memory, optical memory, solid state memory or even remotely mounted memory.

The UE 300a:300d may further comprise a communications interface 320 for communications with other entities, functions, nodes, and devices, such as APs 400a:400h, and centralized nodes 200a:200c, directly or indirectly, as in FIG. 1. As such the communications interface 320 may comprise one or more transmitters and receivers, comprising analogue and digital components.

The processing circuitry 310 controls the general operation of the UE 300a:300d e.g. by sending data and control signals to the communications interface 320 and the storage medium 330, by receiving data and reports from the communications interface 320, and by retrieving data and instructions from the storage medium 330. Other components, as well as the related functionality, of the UE 300a:300d are omitted in order not to obscure the concepts presented herein.

FIG. 10 schematically illustrates, in terms of a number of functional modules, the components of a UE 300a:300d according to an embodiment. The UE 300a:300d of FIG. 10 comprises a number of functional modules; an obtain module 310a configured to perform step S204, a provide module 310c configured to perform step S206, an obtain module 310d configured to perform step S208, and a random access (RA) module 310e configured to perform step S210. The UE 300a:300d of FIG. 10 may further comprise a number of optional functional modules, such as an establish module 310a configured to perform step S202. In general terms, each functional module 310a:310e may be implemented in hardware or in software. Preferably, one or more or all functional modules 310a:310e may be implemented by the processing circuitry 310, possibly in cooperation with the communications interface 320 and/or the storage medium 330. The processing circuitry 310 may thus be arranged to from the storage medium 330 fetch instructions as provided by a functional module 310a:310e and to execute these instructions, thereby performing any steps of the UE 300a:300d as disclosed herein.

FIG. 11 shows one example of a computer program product 1110a, 1110b comprising computer readable means 1130. On this computer readable means 1130, a computer program 1120a can be stored, which computer program 1120a can cause the processing circuitry 210 and thereto operatively coupled entities and devices, such as the communications interface 220 and the storage medium 230, to execute methods according to embodiments described herein. The computer program 1120a and/or computer program product 1110a may thus provide means for performing any steps of the centralized node 200a:200c as herein disclosed. On this computer readable means 1130, a computer program 1120b can be stored, which computer program 1120b can cause the processing circuitry 310 and thereto operatively coupled entities and devices, such as the communications interface 320 and the storage medium 330, to execute methods according to embodiments described herein. The computer program 1120b and/or computer program product 1110b may thus provide means for performing any steps of the UE 300a:300d as herein disclosed.

In the example of FIG. 11, the computer program product 1110a, 1110b is illustrated as an optical disc, such as a CD (compact disc) or a DVD (digital versatile disc) or a Blu-Ray disc. The computer program product 1110a, 1110b could also be embodied as a memory, such as a random access memory (RAM), a read-only memory (ROM), an erasable programmable read-only memory (EPROM), or an electrically erasable programmable read-only memory (EEPROM) and more particularly as a non-volatile storage medium of a device in an external memory such as a USB (Universal Serial Bus) memory or a Flash memory, such as a compact Flash memory. Thus, while the computer program 1120a, 1120b is here schematically shown as a track on the depicted optical disk, the computer program 1120a, 1120b can be stored in any way which is suitable for the computer program product 1110a, 1110b.

The inventive concept has mainly been described above with reference to a few embodiments. However, as is readily appreciated by a person skilled in the art, other embodiments than the ones disclosed above are equally possible within the scope of the inventive concept, as defined by the appended patent claims.

1. A method for selecting a cluster of access points (APs) to serve a user equipment (UE) in a distributed multiple input multiple output (D-MIMO) network, wherein the method is performed by a centralized node in the D-MIMO network, and wherein the method comprises:
obtaining a list of candidate APs from the UE via one of the APs in the D-MIMO network, wherein the UE from all APs in the list of candidate APs has received downlink reference signals with a power higher than a power threshold;
selecting a cluster of APs to serve the UE in the D-MIMO network, wherein the APs are selected from the list of candidate APs based on a cluster selection criterion operating on the list of candidate APs; and
providing a list of the selected APs to the UE by transmitting the list of selected APs via one of the selected APs towards the UE.

2. The method of claim 1, wherein the centralized node is a first centralized node, wherein the D-MIMO network further comprises a second centralized node, and wherein the list of candidate APs comprises at least a first AP controlled by the first centralized node and at least a second AP controlled by the second centralized node.

3. The method of claim 1, wherein said one of the APs from which the list of candidate APs is obtained is controlled by the first centralized node.

4. The method of claim 1, wherein the centralized node is a first centralized node, wherein the D-MIMO network further comprises a second centralized node, and wherein the list of selected APs comprises at least a first AP controlled by the first centralized node and at least a second AP controlled by the second centralized node.

5. The method of claim 1, wherein the cluster selection criterion is an optimization criterion.

6. The method of claim 5, wherein the optimization criterion pertains to at least one of: maximizing a system data rate for the D-MIMO network, maximizing a minimum individual data rate for the UE.

7. The method of claim 1, wherein the cluster selection criterion is based on historical link quality values for previous links between the UE and APs in the D-MIMO network.

8. The method of claim 7, wherein the historical link quality values pertain to pathloss and/or shadowing.

9. The method of claim 1, wherein the cluster selection criterion comprises to randomly select the cluster of APs to serve the UE from the list of candidate APs.

10. The method of claim 2, wherein the cluster selection criterion comprises to only select APs that are controlled by either only the first centralized node or only APs that are controlled by the second centralized node to serve the UE.

11. The method of claim 2, wherein the method further comprises:
informing the second centralized node of the list of candidate APs

12. The method of claim 4, wherein the method further comprises:
informing the second centralized node that said at least second AP is to serve the UE in the D-MIMO network.

13. The method of claim 1, wherein the centralized node is a first centralized node, wherein the D-MIMO network further comprises a second centralized node, and wherein the method further comprises:
receiving, from the second centralized node, a list of further candidate APs for serving a further UE in the D-MIMO network;
informing the second centralized node of a capability of the further candidate APs for serving said further UE.

14. A method for a user equipment (UE) to be assigned a cluster of access points (APs) to serve the UE in a distributed multiple input multiple output (D-MIMO) network, wherein the method is performed by the UE, and wherein the method comprises:
obtaining a list of candidate APs by sounding a radio environment of the UE for reception of downlink reference signals from the APs in the D-MIMO network and selecting to include in the list of candidate APs all of the APs for which the downlink reference signals were received with a power higher than a power threshold;
providing the list of candidate APs to a centralized node in the D-MIMO network by transmitting the list of candidate APs via one of the APs in the list of candidate APs towards the centralized node;
obtaining a list of selected APs from the centralized node via one of the APs in the list of selected APs, whereby the UE is assigned its cluster of APs; and
performing a random access (RA) procedure with the APs in the list of selected APs for the APs in the list of selected APs to start serving the UE in the D-MIMO network.

15. The method of claim 14, wherein the method further comprises:
establishing a connection to one of the APs in the D-MIMO network before obtaining the list of candidate APs, wherein the list of candidate APs is sent to said one of the APs, and wherein the list of selected APs is received from said one of the APs.

16. The method of claim 14, wherein the centralized node is a first centralized node, wherein the D-MIMO network further comprises a second centralized node, and wherein the list of candidate APs comprises at least a first AP controlled by the first centralized node and at least a second AP controlled by the second centralized node.

17. The method of claim 16, wherein said one of the APs is controlled by the first centralized node.

18. The method of claim 14, wherein the centralized node is a first centralized node, wherein the D-MIMO network further comprises a second centralized node, and wherein the list of selected APs comprises at least a first AP controlled by the first centralized node and at least a second AP controlled by the second centralized node.

19. A centralized node for selecting a cluster of access points (APs) to serve a user equipment (UE in a distributed multiple input multiple output (D-MIMO) network, the centralized node comprising processing circuitry, the processing circuitry being configured to cause the centralized node to:
obtain a list of candidate APs from the UE via one of the APs in the D-MIMO network, wherein the UE from all APs in the list of candidate APs has received downlink reference signals with a power higher than a power threshold;
select a cluster of APs to serve the UE in the D-MIMO network, wherein the APs are selected from the list of candidate APs based on a cluster selection criterion operating on the list of candidate APs; and
provide a list of the selected APs to the UE by transmitting the list of selected APs via one of the selected APs towards the UE.

20-21. (canceled)

22. A user equipment (UE) to be assigned a cluster of access points (APs) to serve the UE in a distributed multiple input multiple output (D-MIMO), network, the UE comprising processing circuitry, the processing circuitry being configured to cause the UE to:
obtain a list of candidate APs by sounding a radio environment of the UE for reception of downlink reference signals from the APs in the D-MIMO network and selecting to include in the list of candidate APs all of the APs for which the downlink reference signals were received with a power higher than a power threshold;
provide the list of candidate APs to a centralized node in the D-MIMO network by transmitting the list of candidate APs via one of the APs in the list of candidate APs towards the centralized node;
obtain a list of selected APs from the centralized node via one of the APs in the list of selected APs, whereby the UE is assigned its cluster of APs; and
perform a random access (RA) procedure with the APs in the list of selected APs for the APs in the list of selected APs to start serving the UE in the D-MIMO network.

23-24. (canceled)

25. A non-transitory computer readable medium storing a computer program for selecting a cluster of access points (APs) to serve a user equipment, (UE) in a distributed multiple input multiple output (D-MIMO) network, the computer program comprising computer code which, when run on processing circuitry of a centralized node, causes the centralized node to:
obtain a list of candidate APs from the UE via one of the APs in the D-MIMO network, wherein the UE from all APs in the list of candidate APs has received downlink reference signals with a power higher than a power threshold;
select a cluster of APs to serve the UE in the D-MIMO network, wherein the APs are selected from the list of candidate APs based on a cluster selection criterion operating on the list of candidate APs; and
provide a list of the selected APs to the UE by transmitting the list of selected APs via one of the selected APs towards the UE.

26. A non-transitory computer readable medium storing a computer program for a user equipment (UE) to be assigned a cluster of access points (APs) to serve the UE in a distributed multiple input multiple output (D-MIMO) network, the computer program comprising computer code which, when run on processing circuitry of the UE, causes the UE to:
obtain a list of candidate APs by sounding a radio environment of the UE for reception of downlink reference signals from the APs in the D-MIMO network and selecting to include in the list of candidate APs all of the APs for which the downlink reference signals were received with a power higher than a power threshold;
provide the list of candidate APs to a centralized node in the D-MIMO network by transmitting the list of candidate APs via one of the APs in the list of candidate APs towards the centralized node;
obtain a list of selected APs from the centralized node via one of the APs in the list of selected APs, whereby the UE is assigned its cluster of APs; and
perform a random access (RA) procedure with the APs in the list of selected APs for the APs in the list of selected APs to start serving the UE in the D-MIMO network.

27. (canceled)
